(19) United States
(12) Patent Application Publication
(10) Pub. No.: US 2024/0147485 A1
(43) Pub. Date: May 2, 2024

(54) COORDINATION BETWEEN CONNECTED USER EQUIPMENTS AND THE NETWORK

(71) Applicant: QUALCOMM Incorporated, San Diego, CA (US)

(72) Inventors: Aria Hasanzadezonuzy, Somerville, NJ (US); Navid Abedini, Basking Ridge, NJ (US); Jianghong Luo, Skillman, NJ (US); Naeem Akl, Bridgewater, NJ (US); Junyi Li, Fairless Hills, PA (US); Tao Luo, San Diego, CA (US)

(21) Appl. No.: 18/051,827

(22) Filed: Nov. 1, 2022

(51) Int. Cl. H04W 72/12; H04W 68/00; H04W 68/02; H04W 76/28

(52) U.S. Cl. CPC H04W 72/1289; H04W 68/005; H04W 68/02; H04W 76/28

(57) ABSTRACT

Methods, systems, and devices for wireless communications are described. The techniques described herein relate to a user equipment (UE) receiving, from a network entity while in a connected mode with the network entity, first control signaling indicating a coordination configuration. The coordination configuration indicates a subset of paging cycles from a set of paging cycles, the subset of paging cycles associated with an indication of a tracking reference signal (TRS) availability or an indication of a system information (SI) change message availability. The UE receives from the network entity via a paging cycle of the subset of paging cycles in accordance with the coordination configuration, second control signaling indicating an availability of a TRS in a TRS resource or an availability of an SI change message in the paging cycle. The UE receives from the network entity, the TRS or the SI change message based on the second control signaling.

### FIELD OF TECHNOLOGY

The following relates to wireless communications, including coordination between connected user equipments and the network.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support coordination between connected user equipments (UEs) and the network. The network may indicate tracking reference signal (TRS) resources via a system information block (SIB), such as SIB17. A network entity may transmit control signaling that may indicate to a UE in a radio resource control (RRC) connected mode with the network entity a coordination configuration that indicates a subset of idle mode discontinuous reception (I-DRX) paging cycles that include a TRS availability indication. The coordination configuration may be indicated semi-statically, such as in system information (SI), semi-persistently, such as via RRC, or dynamically via a medium access control (MAC) control element (MAC-CE) or downlink control information (DCI). The UE may monitor the paging occasion in the subset of I-DRX cycles to receive the TRS availability indications that identify the SIB configured TRS resources via which TRSs are transmitted. The UE may accordingly monitor for and receive TRS(s) in accordance with the TRS availability indications. Additionally, or alternatively, in some examples, the coordination configuration may indicate the subset of I-DRX cycles that include an indication of whether an SI change message is available.

A method for wireless communications at a UE is described. The method may include receiving, from a network entity while in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability, receiving, from the network entity via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle, and receiving, from the network entity, the TRS or the SI change message based on the second control signaling.

An apparatus for wireless communications at a UE is described. The apparatus may include a processor, memory coupled with the processor, and instructions stored in the memory. The instructions may be executable by the processor to cause the apparatus to receive, from a network entity while in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability, receive, from the network entity via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle, and receive, from the network entity, the TRS or the SI change message based on the second control signaling.

Another apparatus for wireless communications at a UE is described. The apparatus may include means for receiving, from a network entity while in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability, means for receiving, from the network entity via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle, and means for receiving, from the network entity, the TRS or the SI change message based on the second control signaling.

A non-transitory computer-readable medium storing code for wireless communications at a UE is described. The code may include instructions executable by a processor to receive, from a network entity while in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability, receive, from the network entity via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle, and receive, from the network entity, the TRS or the SI change message based on the second control signaling.

Some examples of the method, apparatuses, and non-transitory computer-readable medium described herein may further include operations, features, means, or instructions for receiving third control signaling indicating a set of TRS resources including the TRS resource, where the second control signaling indicates respective availabilities for a set of TRSs in the set of TRS resources.

Some examples of the method, apparatuses, and non-transitory computer-readable medium described herein may further include operations, features, means, or instructions for receiving, with the third control signaling, an indication of a duration in I-DRX paging cycles associated with the indication of the TRS availability for the set of TRS resources, where the respective availabilities of the set of TRSs may be applicable for the duration.

Some examples of the method, apparatuses, and non-transitory computer-readable medium described herein may further include operations, features, means, or instructions for receiving a second TRS in a second I-DRX paging cycle subsequent to the I-DRX paging cycle based on the second control signaling, where the duration may be at least two I-DRX paging cycles.

In some examples of the method, apparatuses, and non-transitory computer-readable medium described herein, receiving the third control signaling may include operations, features, means, or instructions for receiving the third control signaling via a SIB.

In some examples of the method, apparatuses, and non-transitory computer-readable medium described herein, receiving the first control signaling may include operations, features, means, or instructions for receiving the first control signaling indicating the coordination configuration indicating a quantity of I-DRX paging cycles in the set of I-DRX paging cycles.

In some examples of the method, apparatuses, and non-transitory computer-readable medium described herein, receiving the first control signaling may include operations, features, means, or instructions for receiving the first control signaling indicating the coordination configuration indicating a temporally first I-DRX paging cycle of the subset of I-DRX paging cycles.

In some examples of the method, apparatuses, and non-transitory computer-readable medium described herein, receiving the first control signaling may include operations, features, means, or instructions for receiving the first control signaling indicating the coordination configuration indicating that I-DRX paging cycles of the subset of I-DRX paging cycles may be consecutive.

In some examples of the method, apparatuses, and non-transitory computer-readable medium described herein, receiving the first control signaling may include operations, features, means, or instructions for receiving the first control signaling indicating the coordination configuration indicating a temporally last I-DRX paging cycles in the subset of I-DRX paging cycles.

In some examples of the method, apparatuses, and non-transitory computer-readable medium described herein, receiving the first control signaling may include operations, features, means, or instructions for receiving the first control signaling indicating the coordination configuration indicating a quantity of I-DRX paging cycles in the subset of I-DRX paging cycles.

In some examples of the method, apparatuses, and non-transitory computer-readable medium described herein, receiving the first control signaling may include operations, features, means, or instructions for receiving the first control signaling indicating the coordination configuration indicating that I-DRX paging cycles of the subset of I-DRX paging cycles may be staggered.

In some examples of the method, apparatuses, and non-transitory computer-readable medium described herein, receiving the first control signaling may include operations, features, means, or instructions for receiving the first control signaling indicating the coordination configuration indicating a position of the subset of I-DRX paging cycles within the set of I-DRX paging cycles.

In some examples of the method, apparatuses, and non-transitory computer-readable medium described herein, identifying, based on an identifier associated with the UE, a paging occasion from a set of multiple paging occasions of the I-DRX paging cycle, where receiving the second control signaling includes receiving the second control signaling via the paging occasion.

In some examples of the method, apparatuses, and non-transitory computer-readable medium described herein, receiving the first control signaling may include operations, features, means, or instructions for receiving an indication of a paging occasion from a set of multiple paging occasions, where each I-DRX paging cycle includes the set of multiple paging occasions, where receiving the second control signaling includes receiving the second control signaling via the paging occasion.

A method for wireless communications at a network entity is described. The method may include transmitting, to a UE in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability, transmitting, to the UE via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle, and transmitting, to the UE, the TRS or the SI change message in accordance with second control signaling.

An apparatus for wireless communications at a network entity is described. The apparatus may include a processor, memory coupled with the processor, and instructions stored in the memory. The instructions may be executable by the processor to cause the apparatus to transmit, to a UE in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability, transmit, to the UE via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle, and transmit, to the UE, the TRS or the SI change message in accordance with second control signaling.

Another apparatus for wireless communications at a network entity is described. The apparatus may include means for transmitting, to a UE in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability, means for transmitting, to the UE via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle, and means for transmitting, to the UE, the TRS or the SI change message in accordance with second control signaling.

A non-transitory computer-readable medium storing code for wireless communications at a network entity is described. The code may include instructions executable by a processor to transmit, to a UE in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability, transmit, to the UE via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle, and transmit, to the UE, the TRS or the SI change message in accordance with second control signaling.

Some examples of the method, apparatuses, and non-transitory computer-readable medium described herein may further include operations, features, means, or instructions for transmitting third control signaling indicating a set of TRS resources including the TRS resource, where the second control signaling indicates respective availabilities for a set of TRSs in the set of TRS resources.

Some examples of the method, apparatuses, and non-transitory computer-readable medium described herein may further include operations, features, means, or instructions for transmitting, with the third control signaling, an indication of a duration in I-DRX paging cycles associated with the indication of the TRS availability for the set of TRS resources, where the respective availabilities of the set of TRSs may be applicable for the duration.

Some examples of the method, apparatuses, and non-transitory computer-readable medium described herein may further include operations, features, means, or instructions for transmitting a second TRS in a second I-DRX paging cycle subsequent to the I-DRX paging cycle based on the second control signaling, where the duration may be at least two I-DRX paging cycles.

In some examples of the method, apparatuses, and non-transitory computer-readable medium described herein, transmitting the third control signaling may include operations, features, means, or instructions for transmitting the third control signaling via a SIB.

In some examples of the method, apparatuses, and non-transitory computer-readable medium described herein, transmitting the first control signaling may include operations, features, means, or instructions for transmitting the first control signaling indicating the coordination configuration indicating a quantity of I-DRX paging cycles in the set of I-DRX paging cycles.

In some examples of the method, apparatuses, and non-transitory computer-readable medium described herein, transmitting the first control signaling may include operations, features, means, or instructions for transmitting the first control signaling indicating the coordination configuration indicating a temporally first I-DRX paging cycle of the subset of I-DRX paging cycles.

In some examples of the method, apparatuses, and non-transitory computer-readable medium described herein, transmitting the first control signaling may include operations, features, means, or instructions for transmitting the first control signaling indicating the coordination configuration indicating that I-DRX paging cycles of the subset of I-DRX paging cycles may be consecutive.

In some examples of the method, apparatuses, and non-transitory computer-readable medium described herein, transmitting the first control signaling may include operations, features, means, or instructions for transmitting the first control signaling indicating the coordination configuration indicating a temporally last I-DRX paging cycles in the subset of I-DRX paging cycles.

In some examples of the method, apparatuses, and non-transitory computer-readable medium described herein, transmitting the first control signaling may include operations, features, means, or instructions for transmitting the first control signaling indicating the coordination configuration indicating a quantity of I-DRX paging cycles in the subset of I-DRX paging cycles.

In some examples of the method, apparatuses, and non-transitory computer-readable medium described herein, transmitting the first control signaling may include operations, features, means, or instructions for transmitting the first control signaling indicating the coordination configuration indicating that I-DRX paging cycles of the subset of I-DRX paging cycles may be staggered.

In some examples of the method, apparatuses, and non-transitory computer-readable medium described herein, transmitting the first control signaling may include operations, features, means, or instructions for transmitting the first control signaling indicating the coordination configuration indicating a position of the subset of I-DRX paging cycles within the set of I-DRX paging cycles.

In some examples of the method, apparatuses, and non-transitory computer-readable medium described herein, identifying, based on an identifier associated with the UE, a paging occasion from a set of multiple paging occasions of the I-DRX paging cycle, where transmitting the second control signaling includes transmitting the second control signaling via the paging occasion.

In some examples of the method, apparatuses, and non-transitory computer-readable medium described herein, transmitting the first control signaling may include operations, features, means, or instructions for transmitting an indication of a paging occasion from a set of multiple paging occasions, where each I-DRX paging cycle includes the set of multiple paging occasions, where transmitting the second control signaling includes transmitting the second control signaling via the paging occasion.

### BRIEF DESCRIPTION OF THE DRAWINGS

FIG. 1 illustrates an example of a wireless communications system that supports coordination between connected user equipments (UE)s and the network in accordance with one or more aspects of the present disclosure.

FIG. 2 illustrates an example of a resource diagram that supports coordination between connected UEs and the network in accordance with one or more aspects of the present disclosure.

FIG. 3 illustrates an example of a resource diagram that supports coordination between connected UEs and the network in accordance with one or more aspects of the present disclosure.

FIG. 4 illustrates an example of a wireless communications system that supports coordination between connected UEs and the network in accordance with one or more aspects of the present disclosure.

FIG. 5 illustrates an example of a process flow that supports coordination between connected UEs and the network in accordance with one or more aspects of the present disclosure.

FIGS. 6 and 7 illustrate block diagrams of devices that support coordination between connected UEs and the network in accordance with one or more aspects of the present disclosure.

FIG. 8 illustrates a block diagram of a communications manager that supports coordination between connected UEs and the network in accordance with one or more aspects of the present disclosure.

FIG. 9 illustrates a diagram of a system including a device that supports coordination between connected UEs and the network in accordance with one or more aspects of the present disclosure.

FIGS. 10 and 11 illustrate block diagrams of devices that support coordination between connected UEs and the network in accordance with one or more aspects of the present disclosure.

FIG. 12 illustrates a block diagram of a communications manager that supports coordination between connected UEs and the network in accordance with one or more aspects of the present disclosure.

FIG. 13 illustrates a diagram of a system including a device that supports coordination between connected UEs and the network in accordance with one or more aspects of the present disclosure.

FIGS. 14 and 15 illustrate flowcharts showing methods that support coordination between connected UEs and the network in accordance with one or more aspects of the present disclosure.

### DETAILED DESCRIPTION

In wireless communications systems, a network entity may transmit reference signals that may be used for various purposes. Example reference signals include: demodulation reference signals (DMRS)s, which may be used for both uplink and downlink communications; phase racking reference signals (PTRS)s, which may be used for both uplink and downlink communications; positioning reference signals (PRS)s, which may be used in downlink communications; sounding reference signals (SRS)s, which may be used in uplink communications; remote interference management reference signals (RIM-RS)s, which may be used in downlink communications; and channels state information (CSI) reference signals (CSI-RS)s, which may be used in downlink communications. CSI-RSs may be used for channel and interference measurement for CSI feedback from a user equipment (UE) to the network. CSI-RS s may also be used for measurement for beam management, receive beam sweeping at the user equipment (UE), frequency and time tracking, and mobility measurement for radio resource management (RRM). A tracking reference signal (TRS) is a type or application of a CSI-RS.

A network entity may transmit TRSs, which a UE may use for frequency and time tracking or for channel delay spread and doppler spread estimation. A UE may also use TRSs for automatic gain control (AGC) or power delay profile. A TRS may be a CSI-RS resource configured with the higher layer parameter trs-Info. In wireless communications systems, TRS resources for a radio resource control (RRC) connected UE (e.g., a UE in an RRC connected mode with a network entity) may be configured by RRC, and the UE may monitor the configured TRS resources for TRSs transmitted by the network entity. For example, TRSs may be configured via a non-zero power (NZP) CSI-RS resource set information element (IE) in RRC. For example, connected mode UEs may expect to receive the higher layer UE specific configuration of an NZP-CSI-RS-ResourceSet IE configured with the higher layer parameter trs-info. The network may indicate TRS resources via a system information block (SIB), such as SIB17, for UEs in an RRC idle or RRC inactive mode. To save power at the network, in some examples, the network may not indicate TRS resources in RRC, and may instead indicate the TRS resources in a SIB (e.g., in a SIB17). For TRS resources configured by a SIB, the network may indicate via layer 1 signaling (e.g., in a paging frame or a paging occasion of an idle mode discontinuous reception (I-DRX) cycle) whether the network will transmit TRSs in the SIB configured TRS resources. For example, the network may indicate the availability of SIB configured TRS resource sets via paging a physical downlink control channel (PDCCH) and/or a paging error indication (PEI).

The network may not indicate via the layer 1 signaling, however, in each I-DRX cycle (e.g., paging cycle) whether the TRS will be available in a given TRS resource. For example, the indication of whether TRS s will be available in TRS resources may be valid for multiple I-DRX cycles. The RRC connected UEs may not monitor each paging frame in each I-DRX cycle. An RRC connected UEs may monitor at least one paging occasion per modification period, where a modification period is 2, 4, 8, or 16 I-DRX cycles. The paging occasion in the modification period may be used to indicate a change of system information (SI) for RRC connected mode UEs. Accordingly, an RRC connected mode UE may miss an indication of whether a TRS will be transmitted in a given SIB configured TRS resource if the indication is not transmitted in every I-DRX cycle.

Accordingly, the network may transmit control signaling indicating to an RRC connected mode UE a coordination configuration that indicates subset of I-DRX cycles that include a TRS availability indication. The coordination configuration may be indicated semi-statically, such as in SI, semi-persistently, such as via RRC, or dynamically via a medium access control (MAC) control element (MAC-CE) or downlink control information (DCI). The UE may monitor the paging occasions in the subset of I-DRX cycles to receive the TRS availability indications that identify the SIB configured TRS resources via which TRSs are transmitted. The coordination configuration may indicate the subset of I-DRX cycles based on indicating the borders of the period where TRS availability is (e.g., the I-DRX cycles based on system occasion numbers). The coordination configuration may indicate whether I-DRX cycles that include TRS availability indications are consecutive, and accordingly either a set (e.g., a number) of consecutive I-DRX cycles, a starting I-DRX cycle, or an ending I-DRX cycle. In some examples, the coordination configuration may indicate indices or integer numbers identifying the I-DRX cycles that include the TRS availability information. The UE may receive the TRSs in accordance with the TRS availability indications. Additionally, or alternatively, in some examples, the coordination configuration may indicate the subset of I-DRX cycles that include an indication of whether an SI change message is available.

Aspects of the disclosure are initially described in the context of wireless communications systems. Aspects of the disclosure are further illustrated by and described with reference to resource diagrams and process flows. Aspects of the disclosure are further illustrated by and described with reference to apparatus diagrams, system diagrams, and flowcharts that relate to coordination between connected user equipments and the network.

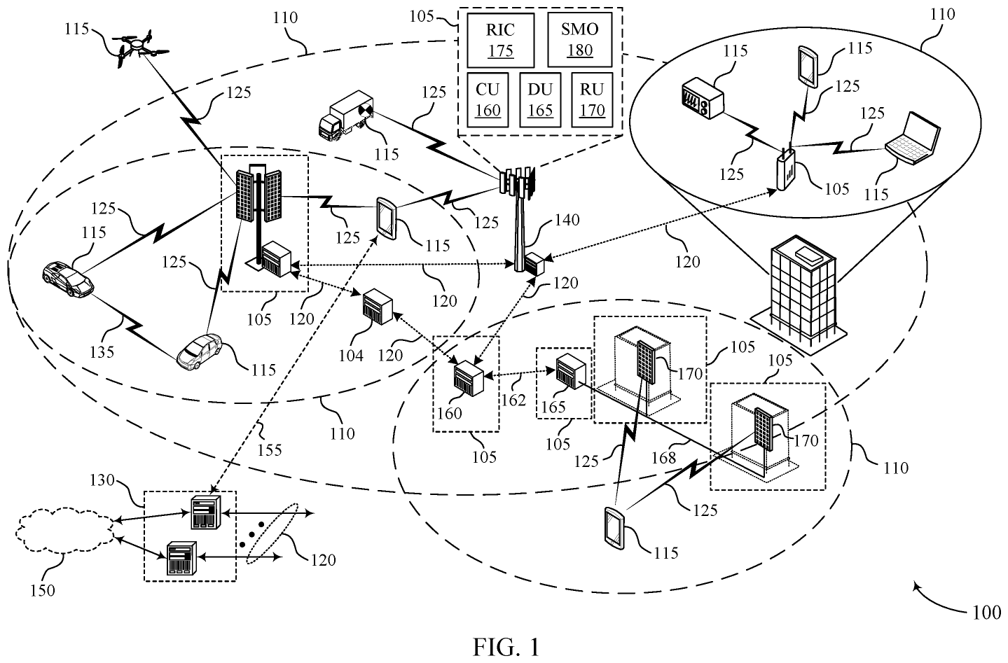

FIG. 1 illustrates an example of a wireless communications system 100 that supports coordination between connected user equipments and the network in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support coordination between connected UEs 115 and the network as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNB s or gNB s, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, SI), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N f may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A network entity 105 may transmit a SIB indicating TRS resources. A network entity 105 may transmit control signaling may indicate to an RRC connected mode UE 115 a coordination configuration that indicates subset of paging cycles, such as I-DRX cycles, that include a TRS availability indication for the TRS resources. The coordination configuration may be indicated semi-statically, such as in SI, semi-persistently, such as via RRC, or dynamically via a via a MAC-CE or DCI. The UE 115 may monitor paging occasions (e.g., paging frames) in the subset of paging cycles (e.g., subset of I-DRX cycles) to receive the TRS availability indications that identify the SIB configured TRS resources via which the TRSs are transmitted. The coordination configuration may indicate the subset of paging cycles based on indicating the borders of the period where TRS availability is indicated (e.g., the paging cycles based on system frame numbers). The coordination configuration may indicate whether paging cycles that include TRS availability indications are consecutive, and accordingly either a set (e.g., a number) of consecutive paging cycles, a starting paging cycle, or an ending paging cycle. In some examples, the coordination configuration may indicate indices or integer numbers identifying the paging cycles that include the TRS availability information. The UE 115 may receive the TRSs in accordance with the TRS availability indications. Additionally, or alternatively, in some examples, the coordination configuration may indicate the subset of paging cycles that include an indication of whether an SI change message is available.

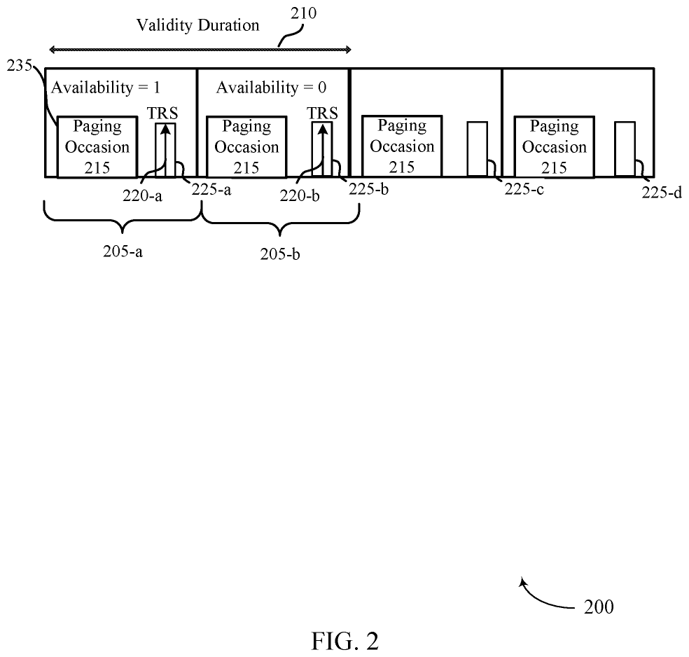

FIG. 2 illustrates an example of a resource diagram 200 that supports coordination between connected UEs and the network in accordance with one or more aspects of the present disclosure. As described herein, a network entity may configure a set of TRS resources 225 via a SIB. The resource diagram 200 illustrates multiple paging cycles 205 (e.g., I-DRX cycles). The network may indicate, via a paging occasion, whether a TRS 220 will be available in a configured TRS resource 225. The indication that a TRS 220 is available in a TRS resource 225 may be valid for a validity duration 210. The start of the validity duration 210 may be the first paging occasion 215 from a current default paging cycle 205-a of when a UE 115 receives an availability indication 235. A duration value of the validity duration 210 may be configured by a higher layer as one or more paging cycles 205, such as 1, 2, 4, 8, 16, 32, 64, 128, 256, 512, and so forth. In some examples, the validity duration 210 may be set to infinity (e.g., a constantly valid). As such, when the validity duration 210 is set to infinity, the availability indication 235 may not be sent during a particular paging occasion 215 since the TRS resource (e.g., TRS resource set) is constantly available.

The availability of the TRS in the availability indication 235 may be indicated by layer 1 (L1) signaling in PDCCH or PEI. For example, the paging occasion 215 may be transmitted via a PDCCH or a PEI. The same design principle may be used for a TRS availability indication using PDCCH or PEI (e.g., for both DCI formats associated with PDCCH or PEI). The L1 signaling for the PDCCH or PEI may indicate TRS availability via a bitmap. The number of bits in the bitmap may correspond to the number of TRS resources or resource groups (e.g., 6 different resource groups). For example, the SIB may configure 6 different TRS resources, and bits in the bitmap may indicate the availability of TRSs in the different TRS resources. In some examples, the bitmap may include up to 6 bits, indicating 6 TRS resource groups. The availability indication 235 may include a bit value of 1 or 0, where 1 indicates that the TRS resource group of the bitmap is available and 0 holds an previously received availability of the TRS resource group without extending the validity duration 210.

In the resource diagram 200, the validity duration 210 is 2 paging cycles 205. The validity duration 210 may be configured by higher layer signaling (e.g., RRC or the SIB configuring the TRS resources). A paging occasion 215 is sent in a first paging cycle 205-a that indicates (e.g., via a bit value “1”) TRSs 220 are available in the configured TRS resources 225 for the validity duration. In the second paging cycle 205-b, the availability indication 235 indicates a bit value “0”. As such, the availability from the previous paging cycle 205 (e.g., the first paging cycle 205-a) is held but is not extended past the second paging cycle 205-b, and the validity duration 210 is complete. Accordingly, a UE 115 may monitor for and receive the TRS 220-a in the TRS resource 225-a and the TRS 220-b in the TRS resource 225-b, but the UE 115 may not monitor for or receive a TRS in the TRS resource 225-c or the TRS resource 225-d.

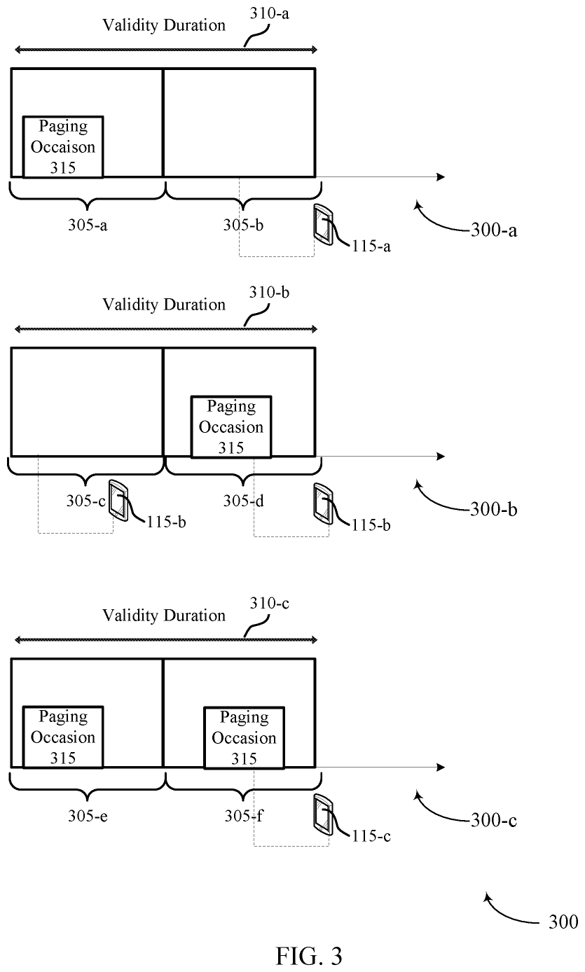

FIG. 3 illustrates an example of a resource diagram 300 that supports coordination between connected UEs and the network in accordance with one or more aspects of the present disclosure. The resource diagram 300-a, the resource diagram 300-b, and the resource diagram 300-c may implement aspects of the wireless communications system 100. For example, the resource diagram 300 may include communications utilized by or communicated between a network entity 105 and a UE 115-a, a UE 115-b, or a UE 115-c, which may be examples of a UE 115 as described herein. A network entity 105 as described herein may communicate with the UE 115-a, the UE 115-b, or the UE 115-c.

As described herein, the network may indicate TRS resources to UEs 115 in an RRC connected mode via a SIB (e.g., SIB17) in order to save power at the network (e.g., instead of UE specific TRS configuration via RRC). For example, the network may transmit an indication of a TRS configurations via SIB17 for UEs 115 in an idle mode or inactive mode, and thus, no additional power is used to transmit TRS indications via SIB17 to the connected UEs 115. UEs 115 in an RRC connected mode, however, may not monitor paging occasions (e.g., via PDCCH) as often as idle or inactive UEs 115.

Connected UEs 115 may monitor one or more paging occasions (e.g., PDCCH) during a modification period. A modification period is the amount of time ({2, 3, 8, 16} number of default paging cycles) where any SI change may be indicated in a short message. Changed SI may be broadcasted from a next or subsequent modification period. The borders of a modification period may be determined via an SFN and a value in (configured via SIB1), where the borders of the modification period are SFN mod m=0.

However, in some examples, if a connected mode UE 115 is configured with TRS resource sets via a SIB, there may not be coordination between the connected mode UE 115 and the network, such that the network may indicate TRS availability. In some examples, as shown in the resource diagram 300-a, a validity duration 310-a includes two paging cycles. During the paging cycle 305-a, the network may send a paging occasion 315 which indicates the TRS may be available in a configured TRS resource, as described with reference to FIG. 2. The paging occasion 315 may indicate the TRS resources availability, the duration (e.g., start of validity duration), or both. However, the UE 115-a may monitor the second paging cycle 305-b in accordance with the configured modification period for the UE 115-a. As such, the UE 115-a may not receive a TRS associated with the paging occasion 315 in the first paging cycle 305-a or in the second paging cycle 305-b.

To ensure that the paging occasion 315 and associated TRS availability indication is received by the UE 115, the UE 115 may monitor each paging cycle. As shown in the resource diagram 300-b, a validity duration 310-b includes two paging cycles. For example, in the resource diagram 300-b, UE 115-b may monitor both paging cycles 305-c and 305-d. In this manner, the UE 115-b may determine whether a paging occasion 315 and associated TRS availability indication is received at a given paging occasion 315. However, monitoring each paging cycle 305 may increase power consumption at the UE 115-b (e.g., with respect to UE 115-a, which does not monitor each paging occasion 315).

As another example, in the resource diagram 300-c, the network may send a TRS availability indication in each paging occasion 315 in each of the paging cycles 305 to ensure that the UE 115-c receives the paging occasion 315. As shown in the resource diagram 300-c, a validity duration 310-c includes two paging cycles. That is, even if the UE 115-c monitors some paging cycles 305 and not others, the UE 115-c may receive the paging occasion 315 since the network sends the TRS availability indication in each paging cycle 305. In this example, the network sends the paging occasion 315 including the TRS availability indication in each of the paging cycle 305-e and the paging cycle 305-f. Even though UE 115-c may monitor the paging cycle 305-f, the UE 115-c will receive the paging occasion 315 including the TRS availability indication since the network sends the paging occasion 315 including the TRS availability indication in each paging cycle 305. However, including a TRS availability indication in each paging occasions 315 in each paging cycle 305 may increase power consumption at the network (e.g., with respect to the network sending the paging occasion 315 in one paging cycle 305 or a subset of paging cycles 305 of the validity duration 310).

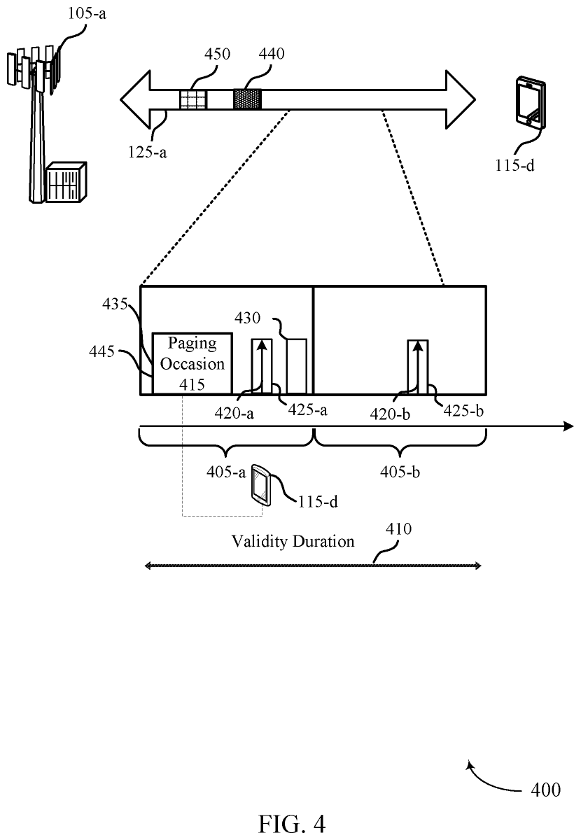

FIG. 4 illustrates an example of a wireless communications system 400 that supports coordination between connected UEs and the network in accordance with one or more aspects of the present disclosure. The wireless communications system 400 may implement aspects of the wireless communications system 100. For example, the wireless communications system 400 may include a UE 115-d, which may be an example of a UE 115 as described herein. The wireless communications system 400 may include a network entity 105-a, which may be an example of a network entity 105 as described herein.

The UE 115-d may communicate with the network entity 105-a using a communication link 125-a. The communication link 125-a may be an example of an NR or LTE link between the UE 115-d and the network entity 105-a. The communication link 125-a may include bi-directional links that enable both the uplink and downlink communication. For example, the UE 115-d may transmit uplink signals (e.g., uplink transmissions), such as uplink control signals or uplink data signals, to the network entity 105-a using the communication link 125-a and the network entity 105-a may transmit downlink signals (e.g., downlink transmissions), such as downlink control signals or downlink data signals, to the UE 115-d using the communication link 125-a.

The UE 115-d is a connected mode UE 115 as described herein. The network entity 105-a may transmit a SIB 450 indicating a set of TRS resources 425. The network entity 105-a may coordinate with the UE 115-d so that the UE 115-d monitors or listens for a TRS availability indication 435 in a paging occasion 415 during a particular paging cycle 405. In this manner, both the network and the UE 115-d may reduce power consumption by the network not sending paging occasions 415 in each paging cycle 405 or the UE 115-d not monitoring each paging cycle 405.

If the UE 115-d in a connected mode does not receive a dedicated RRC message indicating TRS resources, and instead is configured with a set of TRS resources via a SIB, and the validity duration 410 is not infinity, the UE 115-d may monitor paging occasions 415 (e.g., PDCCHs or PEIs) in a coordinated manner for TRS availability information (e.g., the same monitoring occasions may be used for idle mode or inactive mode UEs 115). For example, the network entity 105-a may transmit control signaling 440 indicating coordination configuration indication a subset of paging cycles 405 of a set of paging cycles that include a TRS availability indication 435. For example, the control signaling may indicate that the paging cycle 405-a includes a TRS availability indication 435. Accordingly, the UE 115-d may monitor the paging occasion 415 in the paging cycle 405-a for the TRS availability indication 435. If the TRS availability indication 435 indicates that a TRS is available in a TRS resource 425-a, the UE 115-d may monitor for and receive the TRS 420-a in the TRS resource 425-a. The TRS availability indication may be valid for the validity duration 410, which may include the paging cycle 405-b. Accordingly, the UE 115-d may monitor for and receive the TRS 420-b in the TRS resource 425-b. The network entity 105-a may also indicate which paging cycles to monitor for an SI change message 430. For example, the coordination configuration indicated by the control signaling 440 may indicate a subset of paging cycles 405 of a set of paging cycles that include an SI change message availability indication 445. The UE 115-d may monitor for the indication of the SI change message availability indication 445 in the indicated paging cycles 405 (e.g., in the paging cycle 405-a), and may accordingly monitor for and receive an SI change message 430 based on the SI change message availability indication. Coordinating the subset of paging cycles 405 to monitor for a TRS availability indication 435 and/or an SI change message availability indication 445 may save power at both the network and the UE 115-d.

In some examples, the coordination configuration indicated by the control signaling 440 may indicate more than one paging cycle of a set of multiple paging cycles to monitor for the TRS availability indication 435 and/or an SI change message availability indication 445. For example, more than one paging cycle 405 may be used so that the UE 115-d may not miss the TRS availability indication 435 and/or the SI change message availability indication 445. The coordination configuration may be indicated semi-statically, (e.g., the control signaling 440 may be an SI message). In some examples, the coordination configuration may be indicated semi-persistently, for example the control signaling 440 may be an RRC message and the coordination configuration may be updated via RRC signaling, a MAC-CE, or a DCI. In some examples, the coordination configuration may be indicated dynamically (e.g., the control signaling 440 may be a MAC-CE or a DCI).

The UE 115 may monitor the paging occasions in the subset of paging cycles to receive the TRS availability indications that identify the SIB configured TRS resources via which TRSs are transmitted. The coordination configuration may indicate a value “n” which may be used to determine a border of a set of paging cycles 405. “n” may be an integer value such than SFN mod n=0. Accordingly, the borders of the period where the TRS availability indication is broadcasted may be determined by the UE 115-d. In some examples, the coordination configuration may include a field “staggered,” which be a true/false value (e.g., represented by “0” or “1”) that indicates whether the paging cycles 405 where the TRS availability indication 435 are sent are consecutive. If “staggered” is false, then paging cycles with the TRS availability indication 435 are consecutive. In some examples, the coordination configuration may include a field “offset,” which may be an integer value which indicates where paging cycles 405 that include a TRS availability indication 435 from a set of paging cycles 405 begin. For example, if there are four paging cycles and the offset is one, then the UE 115-d may monitor the second, third, and fourth paging cycles. In some examples, the coordination configuration may include a field “N” which may be an integer value indicating a number of paging cycles that include a TRS availability indication 435 (e.g., if the “staggered” field is false). In some examples, the coordination configuration may include a field “end” which may be an integer value indicating the last paging cycle 405 with a TRS availability indication 435 (e.g., if the “staggered” field is false). In some examples, the coordination configuration may include a field “S” which may be a set of integer values indicating which paging cycles 405 (e.g., based on an index of the paging cycles) include a TRS availability indication 435 (e.g., if the “staggered” field is true).

In some examples, the coordination information may be cell-specific, UE-specific, or specific to a group of UEs 115. In some examples, there may be more than one paging occasion 415 in a paging cycle 405. The techniques described herein may apply to one or more paging occasions 415 in one or more paging cycles 405. In the applicable techniques, the descriptions of paging occasions 415 may apply or correspond to I-DRX cycles and a modification period may apply or correspond to an I-DRX cycle. In some examples, the UE 115-d may determine which paging occasion 415 to monitor of multiple paging occasions 415 in a paging cycle based on an identifier of the UE 115-d. In some examples, the coordination configuration may indicate which paging occasion 415 to monitor of the multiple paging occasions 415 in the paging cycle 405.

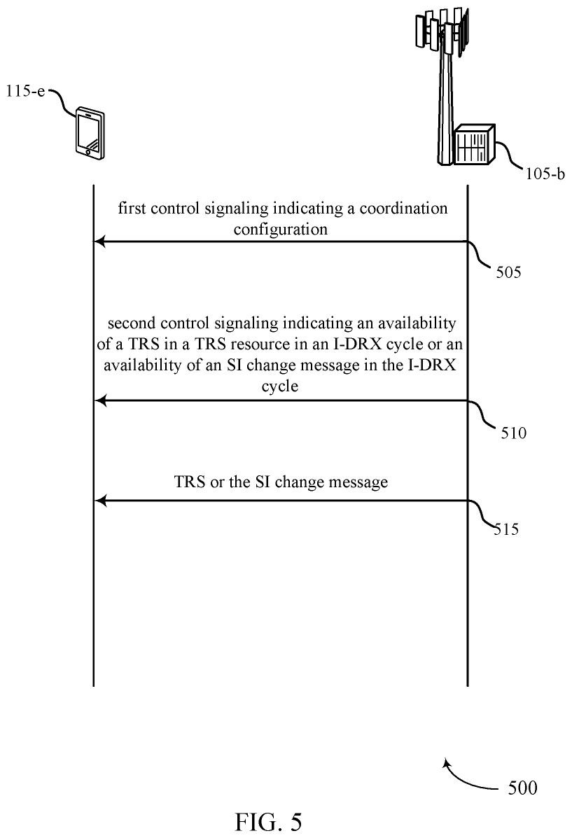

FIG. 5 illustrates an example of a process flow 500 that supports coordination between connected UEs and the network in accordance with one or more aspects of the present disclosure. The process flow 500 may include a UE 115-e, which may be an example of a UE 115 as described herein. The process flow 500 may include a network entity 105-b, which may be an example of a network entity 105 as described herein. In the following description of the process flow 500, the operations between the network entity 105-b and the UE 115-e may be transmitted in a different order than the example order shown, or the operations performed by the network entity 105-b and the UE 115-e may be performed in different orders or at different times. Some operations may also be omitted from the process flow 500, and other operations may be added to the process flow 500.

At 505, the UE 115-e may receive, from the network entity 105-b while in a connected mode with the network entity 105-b, first control signaling indicating a coordination configuration. The coordination configuration indicates a subset of paging cycles, such as I-DRX cycles from a set of I-DRX paging cycles. The subset of I-DRX paging cycles may be associated with an indication of a TRS availability or an indication of an SI change message availability.

At 510, the UE 115-e may receive, from the network entity 105-b via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle.

At 515, the UE 115-e may receive, from the network entity 105-b, the TRS or the SI change message based on the second control signaling.

In some examples, the UE 115-e may receive third control signaling indicating a set of TRS resources comprising the TRS resource, where the second control signaling indicates respective availabilities for a set of TRS in the set of TRS resources. The UE 115-e may receive, with the third control signaling, an indication of a duration in I-DRX paging cycles associated with the indication of the TRS availability for the set of TRS resources, where the respective availabilities of the set of TRS are applicable for the duration. In some examples, the UE 115-e may receive a second TRS in a second I-DRX paging cycle subsequent to the I-DRX paging cycle based on the second control signaling, where the duration is at least two I-DRX paging cycles. In some examples, the third control signaling may be received via a SIB.

In some examples, receiving the first control signaling at 505 includes receiving the first control signal indicating the coordination configuration indicating a quantity of I-DRX paging cycles in the set of I-DRX paging cycles. In some examples, receiving the first control signaling at 505 includes receiving the first control signaling indicating the coordination configuration indicating a temporally first I-DRX paging cycle of the subset of I-DRX paging cycles. In some examples, receiving the first control signaling at 505 includes receiving the first control signaling indicating the coordination configuration indicating that I-DRX paging cycles of the subset of I-DRX paging cycles are consecutive. In some examples, receiving the first control signaling at 505 includes receiving the first control signaling indicating the coordination configuration indicating a temporally last I-DRX paging cycles in the subset of I-DRX cycles. In some examples, receiving the first control signaling at 505 includes receiving the first control signaling indicating the coordination configuration indicating a quantity of I-DRX paging cycles in the subset of I-DRX paging cycles. In some examples, receiving the first control signaling at 505 includes receiving the first control signaling indicating the coordination configuration indicating a position of the subset of I-DRX paging cycles within the set of I-DRX paging cycles. In some examples, receiving the first control signaling at 505 includes receiving an indication of a paging occasion from multiple paging occasions, where each I-DRX paging cycle includes the multiple paging occasions, where receiving the second control signaling at 510 includes receiving the second control signaling via the paging occasion.

In some examples, the UE 115-e may identify, based on an identifier associated with the UE 115-e, a paging occasion from multiple paging occasions of the I-DRX paging cycle, where receiving the second control signaling includes receiving the second control signaling via the paging occasion.

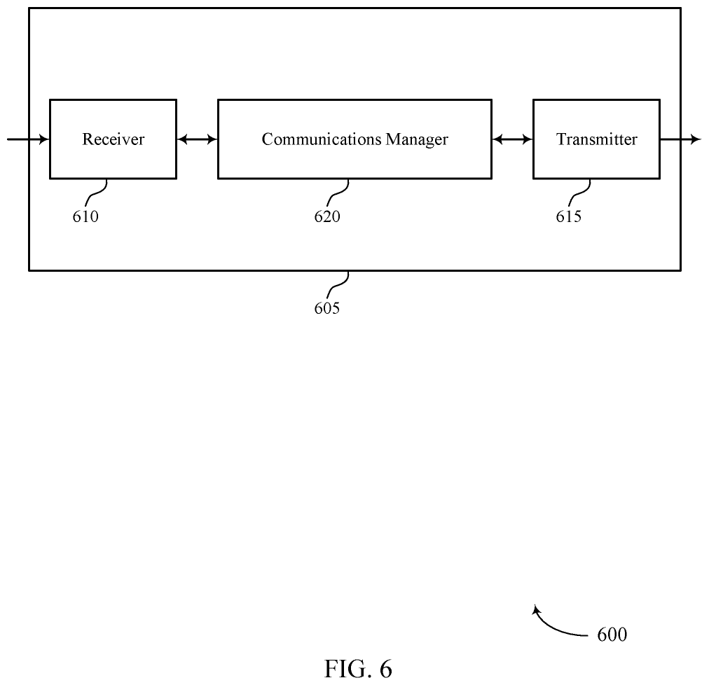

FIG. 6 illustrates a block diagram 600 of a device 605 that supports coordination between connected UEs and the network in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to coordination between connected UEs and the network). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to coordination between connected UEs and the network). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of coordination between connected UEs and the network as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving, from a network entity while in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability. The communications manager 620 may be configured as or otherwise support a means for receiving, from the network entity via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle. The communications manager 620 may be configured as or otherwise support a means for receiving, from the network entity, the TRS or the SI change message based on the second control signaling.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced power consumption and more efficient utilization of communication resources.

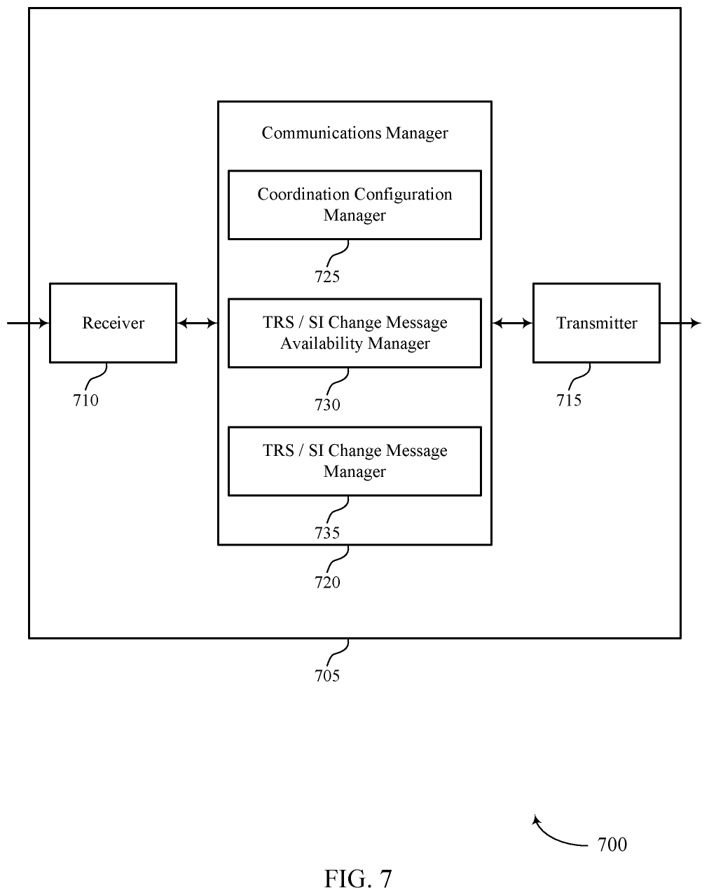

FIG. 7 illustrates a block diagram 700 of a device 705 that supports coordination between connected UEs and the network in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to coordination between connected UEs and the network). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to coordination between connected UEs and the network). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of coordination between connected UEs and the network as described herein. For example, the communications manager 720 may include a coordination configuration manager 725, an TRS/SI change message availability manager 730, an TRS/SI change message manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The coordination configuration manager 725 may be configured as or otherwise support a means for receiving, from a network entity while in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability. The TRS/SI change message availability manager 730 may be configured as or otherwise support a means for receiving, from the network entity via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle. The TRS/SI change message manager 735 may be configured as or otherwise support a means for receiving, from the network entity, the TRS or the SI change message based on the second control signaling.

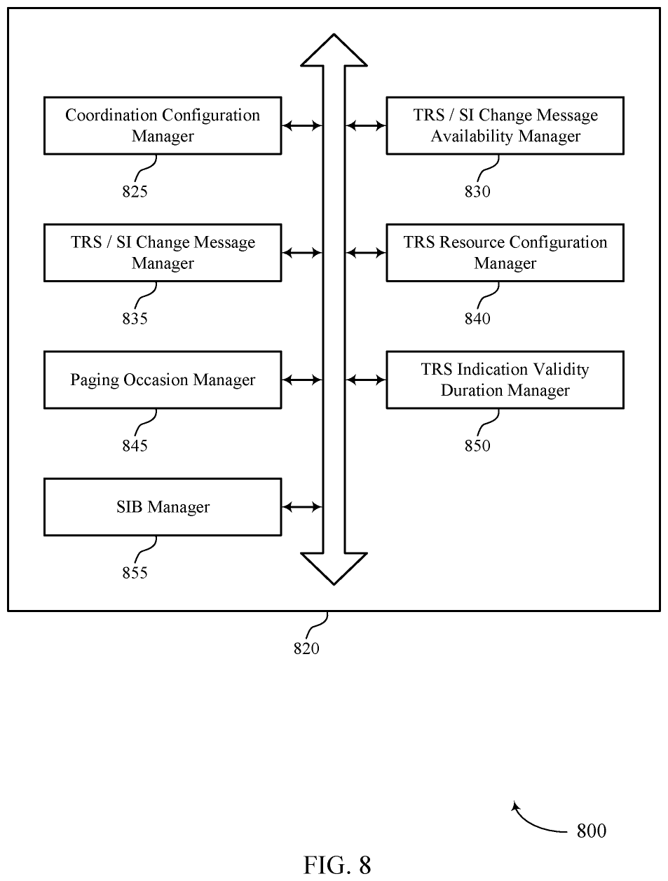

FIG. 8 illustrates a block diagram 800 of a communications manager 820 that supports coordination between connected UEs and the network in accordance with one or more aspects of the present disclosure. The communications manager 820 may be an example of aspects of a communications manager 620, a communications manager 720, or both, as described herein. The communications manager 820, or various components thereof, may be an example of means for performing various aspects of coordination between connected UEs and the network as described herein. For example, the communications manager 820 may include a coordination configuration manager 825, an TRS/SI change message availability manager 830, an TRS/SI change message manager 835, an TRS resource configuration manager 840, a paging occasion manager 845, an TRS indication validity duration manager 850, an SIB manager 855, or any combination thereof. Each of these components may communicate, directly or indirectly, with one another (e.g., via one or more buses).

The communications manager 820 may support wireless communications at a UE in accordance with examples as disclosed herein. The coordination configuration manager 825 may be configured as or otherwise support a means for receiving, from a network entity while in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability. The TRS/SI change message availability manager 830 may be configured as or otherwise support a means for receiving, from the network entity via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle. The TRS/SI change message manager 835 may be configured as or otherwise support a means for receiving, from the network entity, the TRS or the SI change message based on the second control signaling.

In some examples, the TRS resource configuration manager 840 may be configured as or otherwise support a means for receiving third control signaling indicating a set of TRS resources including the TRS resource, where the second control signaling indicates respective availabilities for a set of TRSs in the set of TRS resources.

In some examples, the TRS indication validity duration manager 850 may be configured as or otherwise support a means for receiving, with the third control signaling, an indication of a duration in I-DRX paging cycles associated with the indication of the TRS availability for the set of TRS resources, where the respective availabilities of the set of TRSs are applicable for the duration.

In some examples, the TRS/SI change message manager 835 may be configured as or otherwise support a means for receiving a second TRS in a second I-DRX paging cycle subsequent to the I-DRX paging cycle based on the second control signaling, where the duration is at least two I-DRX paging cycles.

In some examples, to support receiving the third control signaling, the SIB manager 855 may be configured as or otherwise support a means for receiving the third control signaling via a SIB.

In some examples, to support receiving the first control signaling, the coordination configuration manager 825 may be configured as or otherwise support a means for receiving the first control signaling indicating the coordination configuration indicating a quantity of I-DRX paging cycles in the set of I-DRX paging cycles.

In some examples, to support receiving the first control signaling, the coordination configuration manager 825 may be configured as or otherwise support a means for receiving the first control signaling indicating the coordination configuration indicating a temporally first I-DRX paging cycle of the subset of I-DRX paging cycles.

In some examples, to support receiving the first control signaling, the coordination configuration manager 825 may be configured as or otherwise support a means for receiving the first control signaling indicating the coordination configuration indicating that I-DRX paging cycles of the subset of I-DRX paging cycles are consecutive.

In some examples, to support receiving the first control signaling, the coordination configuration manager 825 may be configured as or otherwise support a means for receiving the first control signaling indicating the coordination configuration indicating a temporally last I-DRX paging cycles in the subset of I-DRX paging cycles.

In some examples, to support receiving the first control signaling, the coordination configuration manager 825 may be configured as or otherwise support a means for receiving the first control signaling indicating the coordination configuration indicating a quantity of I-DRX paging cycles in the subset of I-DRX paging cycles.

In some examples, to support receiving the first control signaling, the coordination configuration manager 825 may be configured as or otherwise support a means for receiving the first control signaling indicating the coordination configuration indicating that I-DRX paging cycles of the subset of I-DRX paging cycles are staggered.

In some examples, to support receiving the first control signaling, the coordination configuration manager 825 may be configured as or otherwise support a means for receiving the first control signaling indicating the coordination configuration indicating a position of the subset of I-DRX paging cycles within the set of I-DRX paging cycles.

In some examples, the paging occasion manager 845 may be configured as or otherwise support a means for identifying, based on an identifier associated with the UE, a paging occasion from a set of multiple paging occasions of the I-DRX paging cycle, where receiving the second control signaling includes receiving the second control signaling via the paging occasion.

In some examples, to support receiving the first control signaling, the paging occasion manager 845 may be configured as or otherwise support a means for receiving an indication of a paging occasion from a set of multiple paging occasions, where each I-DRX paging cycle includes the set of multiple paging occasions, where receiving the second control signaling includes receiving the second control signaling via the paging occasion.

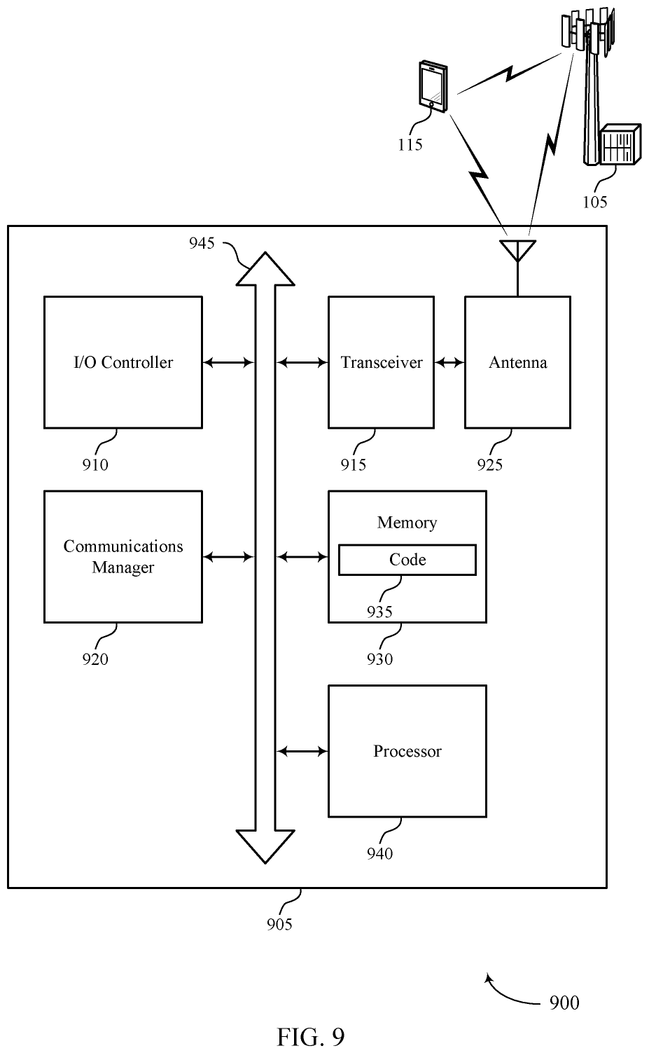

FIG. 9 illustrates a diagram of a system 900 including a device 905 that supports coordination between connected UEs and the network in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting coordination between connected UEs and the network). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, from a network entity while in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability. The communications manager 920 may be configured as or otherwise support a means for receiving, from the network entity via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle. The communications manager 920 may be configured as or otherwise support a means for receiving, from the network entity, the TRS or the SI change message based on the second control signaling.

By including or configuring the communications manager 920 in accordance with examples as described herein, the device 905 may support techniques for reduced power consumption, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of coordination between connected UEs and the network as described herein, or the processor 940 and the memory 930 may be otherwise configured to perform or support such operations.

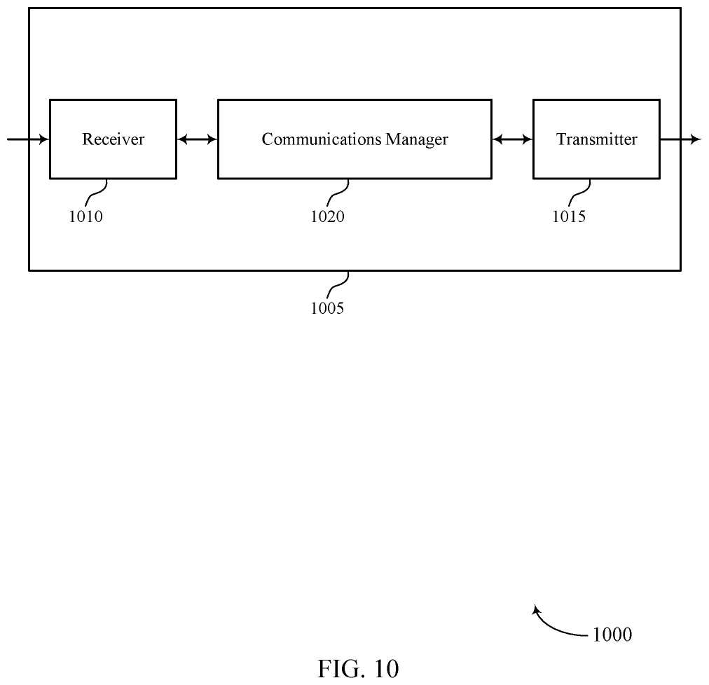

FIG. 10 illustrates a block diagram 1000 of a device 1005 that supports coordination between connected UEs and the network in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of coordination between connected UEs and the network as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for transmitting, to a UE in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability. The communications manager 1020 may be configured as or otherwise support a means for transmitting, to the UE via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle. The communications manager 1020 may be configured as or otherwise support a means for transmitting, to the UE, the TRS or the SI change message in accordance with second control signaling.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced power consumption and more efficient utilization of communication resources.

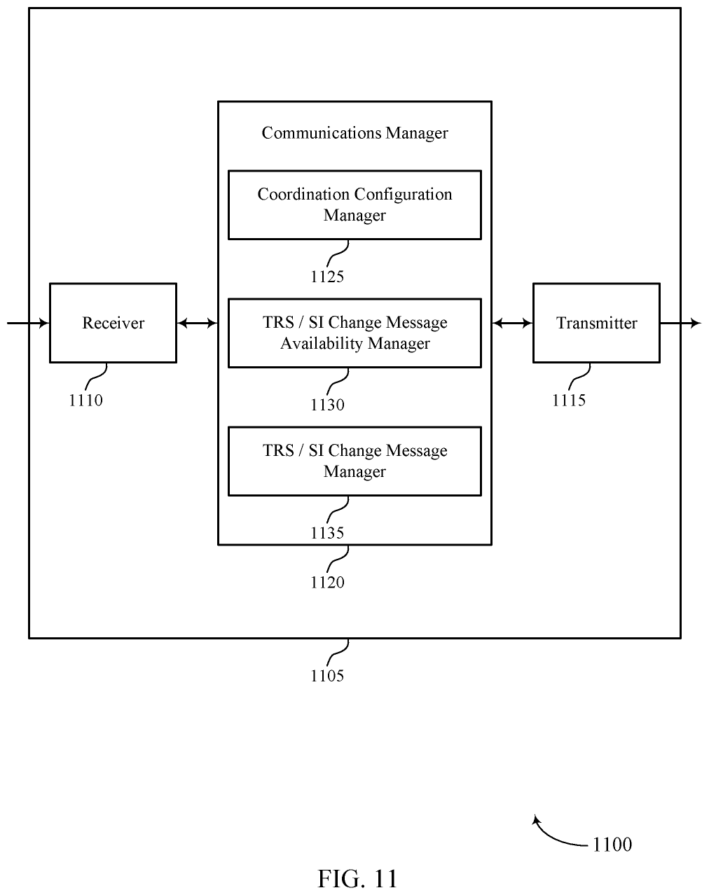

FIG. 11 illustrates a block diagram 1100 of a device 1105 that supports coordination between connected UEs and the network in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of coordination between connected UEs and the network as described herein. For example, the communications manager 1120 may include a coordination configuration manager 1125, an TRS/SI change message availability manager 1130, an TRS/SI change message manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The coordination configuration manager 1125 may be configured as or otherwise support a means for transmitting, to a UE in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability. The TRS/SI change message availability manager 1130 may be configured as or otherwise support a means for transmitting, to the UE via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle. The TRS/SI change message manager 1135 may be configured as or otherwise support a means for transmitting, to the UE, the TRS or the SI change message in accordance with second control signaling.

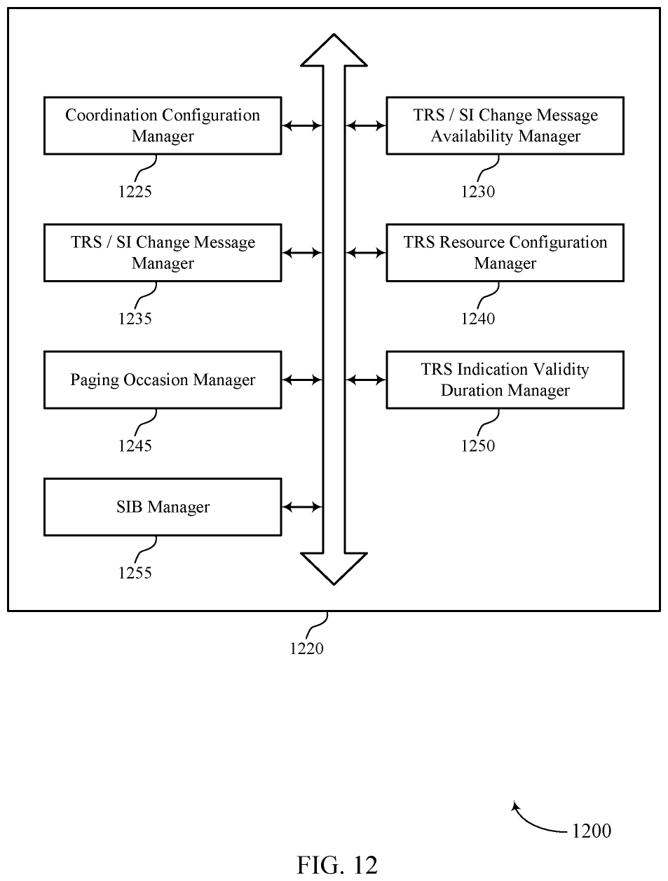

FIG. 12 illustrates a block diagram 1200 of a communications manager 1220 that supports coordination between connected UEs and the network in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of coordination between connected UEs and the network as described herein. For example, the communications manager 1220 may include a coordination configuration manager 1225, an TRS/SI change message availability manager 1230, an TRS/SI change message manager 1235, an TRS resource configuration manager 1240, a paging occasion manager 1245, an TRS indication validity duration manager 1250, an SIB manager 1255, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The coordination configuration manager 1225 may be configured as or otherwise support a means for transmitting, to a UE in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability. The TRS/SI change message availability manager 1230 may be configured as or otherwise support a means for transmitting, to the UE via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle. The TRS/SI change message manager 1235 may be configured as or otherwise support a means for transmitting, to the UE, the TRS or the SI change message in accordance with second control signaling.

In some examples, the TRS resource configuration manager 1240 may be configured as or otherwise support a means for transmitting third control signaling indicating a set of TRS resources including the TRS resource, where the second control signaling indicates respective availabilities for a set of TRSs in the set of TRS resources.

In some examples, the TRS indication validity duration manager 1250 may be configured as or otherwise support a means for transmitting, with the third control signaling, an indication of a duration in I-DRX paging cycles associated with the indication of the TRS availability for the set of TRS resources, where the respective availabilities of the set of TRSs are applicable for the duration.

In some examples, the TRS/SI change message manager 1235 may be configured as or otherwise support a means for transmitting a second TRS in a second I-DRX paging cycle subsequent to the I-DRX paging cycle based on the second control signaling, where the duration is at least two I-DRX paging cycles.

In some examples, to support transmitting the third control signaling, the SIB manager 1255 may be configured as or otherwise support a means for transmitting the third control signaling via a SIB.

In some examples, to support transmitting the first control signaling, the coordination configuration manager 1225 may be configured as or otherwise support a means for transmitting the first control signaling indicating the coordination configuration indicating a quantity of I-DRX paging cycles in the set of I-DRX paging cycles.

In some examples, to support transmitting the first control signaling, the coordination configuration manager 1225 may be configured as or otherwise support a means for transmitting the first control signaling indicating the coordination configuration indicating a temporally first I-DRX paging cycle of the subset of I-DRX paging cycles.

In some examples, to support transmitting the first control signaling, the coordination configuration manager 1225 may be configured as or otherwise support a means for transmitting the first control signaling indicating the coordination configuration indicating that I-DRX paging cycles of the subset of I-DRX paging cycles are consecutive.

In some examples, to support transmitting the first control signaling, the coordination configuration manager 1225 may be configured as or otherwise support a means for transmitting the first control signaling indicating the coordination configuration indicating a temporally last I-DRX paging cycles in the subset of I-DRX paging cycles.

In some examples, to support transmitting the first control signaling, the coordination configuration manager 1225 may be configured as or otherwise support a means for transmitting the first control signaling indicating the coordination configuration indicating a quantity of I-DRX paging cycles in the subset of I-DRX paging cycles.

In some examples, to support transmitting the first control signaling, the coordination configuration manager 1225 may be configured as or otherwise support a means for transmitting the first control signaling indicating the coordination configuration indicating that I-DRX paging cycles of the subset of I-DRX paging cycles are staggered.

In some examples, to support transmitting the first control signaling, the coordination configuration manager 1225 may be configured as or otherwise support a means for transmitting the first control signaling indicating the coordination configuration indicating a position of the subset of I-DRX paging cycles within the set of I-DRX paging cycles.

In some examples, the paging occasion manager 1245 may be configured as or otherwise support a means for identifying, based on an identifier associated with the UE, a paging occasion from a set of multiple paging occasions of the I-DRX paging cycle, where transmitting the second control signaling includes transmitting the second control signaling via the paging occasion.

In some examples, to support transmitting the first control signaling, the paging occasion manager 1245 may be configured as or otherwise support a means for transmitting an indication of a paging occasion from a set of multiple paging occasions, where each I-DRX paging cycle includes the set of multiple paging occasions, where transmitting the second control signaling includes transmitting the second control signaling via the paging occasion.

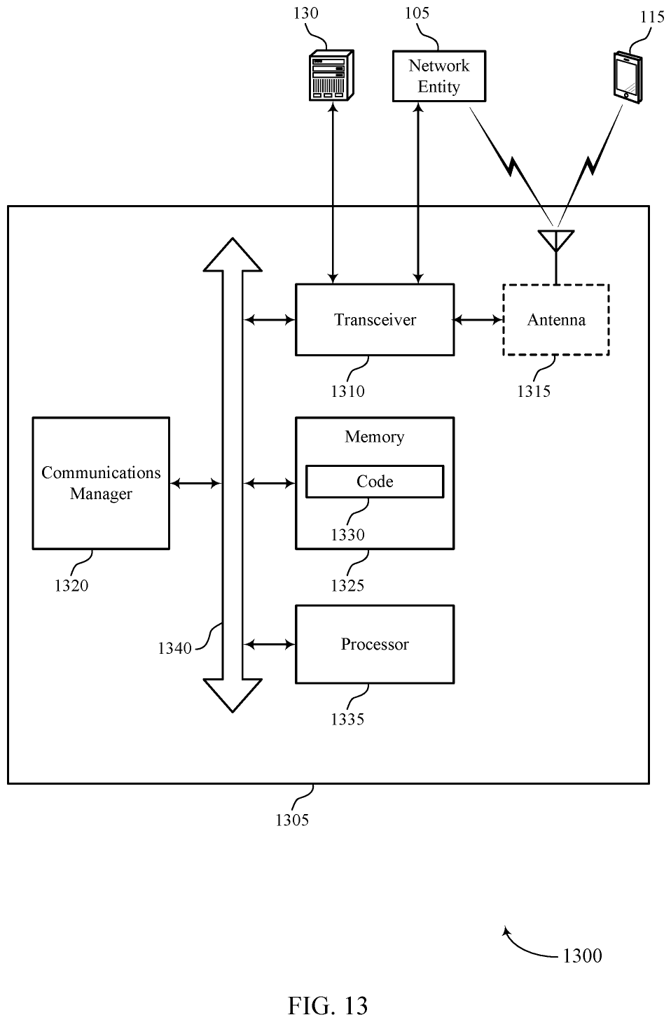

FIG. 13 illustrates a diagram of a system 1300 including a device 1305 that supports coordination between connected UEs and the network in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting coordination between connected UEs and the network). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for transmitting, to a UE in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability. The communications manager 1320 may be configured as or otherwise support a means for transmitting, to the UE via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle. The communications manager 1320 may be configured as or otherwise support a means for transmitting, to the UE, the TRS or the SI change message in accordance with second control signaling.

By including or configuring the communications manager 1320 in accordance with examples as described herein, the device 1305 may support techniques for reduced power consumption, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of coordination between connected UEs and the network as described herein, or the processor 1335 and the memory 1325 may be otherwise configured to perform or support such operations.

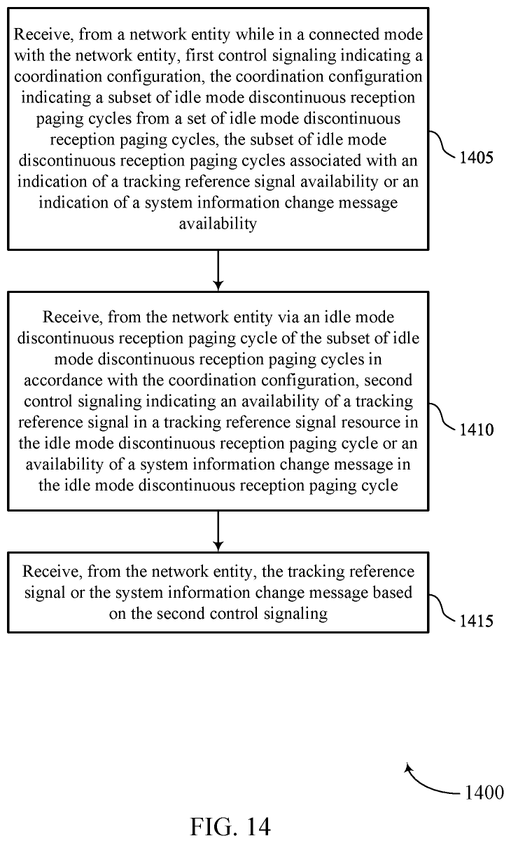

FIG. 14 illustrates a flowchart illustrating a method 1400 that supports coordination between connected UEs and the network in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity while in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability. The operations of 1405 may be performed in accordance with examples as disclosed herein. In some examples, aspects of the operations of 1405 may be performed by a coordination configuration manager 825 as described with reference to FIG. 8.

At 1410, the method may include receiving, from the network entity via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle. The operations of 1410 may be performed in accordance with examples as disclosed herein. In some examples, aspects of the operations of 1410 may be performed by an TRS/SI change message availability manager 830 as described with reference to FIG. 8.

At 1415, the method may include receiving, from the network entity, the TRS or the SI change message based on the second control signaling. The operations of 1415 may be performed in accordance with examples as disclosed herein. In some examples, aspects of the operations of 1415 may be performed by an TRS/SI change message manager 835 as described with reference to FIG. 8.

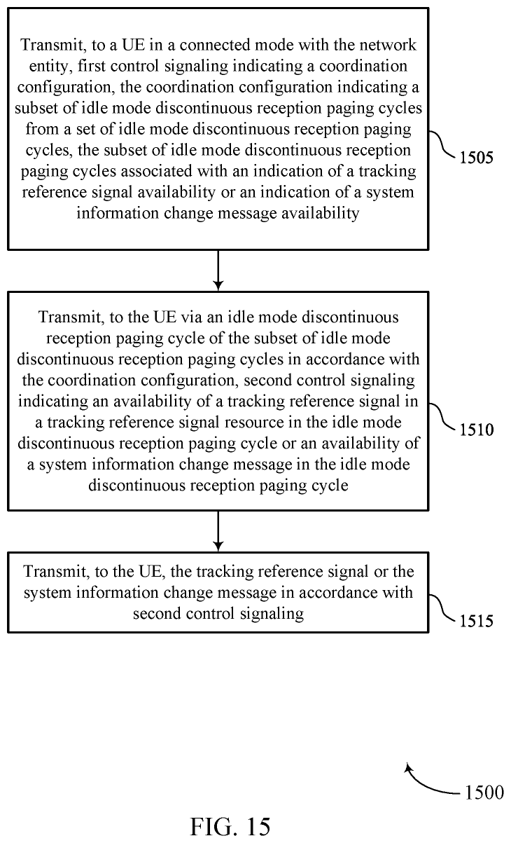

FIG. 15 illustrates a flowchart illustrating a method 1500 that supports coordination between connected UEs and the network in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability. The operations of 1505 may be performed in accordance with examples as disclosed herein. In some examples, aspects of the operations of 1505 may be performed by a coordination configuration manager 1225 as described with reference to FIG. 12.

At 1510, the method may include transmitting, to the UE via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle. The operations of 1510 may be performed in accordance with examples as disclosed herein. In some examples, aspects of the operations of 1510 may be performed by an TRS/SI change message availability manager 1230 as described with reference to FIG. 12.

At 1515, the method may include transmitting, to the UE, the TRS or the SI change message in accordance with second control signaling. The operations of 1515 may be performed in accordance with examples as disclosed herein. In some examples, aspects of the operations of 1515 may be performed by an TRS/SI change message manager 1235 as described with reference to FIG. 12.

The following provides an overview of aspects of the present disclosure:

Aspect 1: A method for wireless communications at a UE, comprising: receiving, from a network entity while in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability; receiving, from the network entity via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle; and receiving, from the network entity, the TRS or the SI change message based at least in part on the second control signaling.

Aspect 2: The method of aspect 1, further comprising: receiving third control signaling indicating a set of TRS resources comprising the TRS resource, wherein the second control signaling indicates respective availabilities for a set of TRSs in the set of TRS resources.

Aspect 3: The method of aspect 2, further comprising: receiving, with the third control signaling, an indication of a duration in I-DRX paging cycles associated with the indication of the TRS availability for the set of TRS resources, wherein the respective availabilities of the set of TRSs are applicable for the duration.

Aspect 4: The method of aspect 3, further comprising: receiving a second TRS in a second I-DRX paging cycle subsequent to the I-DRX paging cycle based at least in part on the second control signaling, wherein the duration is at least two I-DRX paging cycles.

Aspect 5: The method of any of aspects 2 through 4, wherein receiving the third control signaling comprises: receiving the third control signaling via a SIB.

Aspect 6: The method of any of aspects 1 through 5, wherein receiving the first control signaling comprises: receiving the first control signaling indicating the coordination configuration indicating a quantity of I-DRX paging cycles in the set of I-DRX paging cycles.

Aspect 7: The method of aspect 6, wherein receiving the first control signaling comprises: receiving the first control signaling indicating the coordination configuration indicating a temporally first I-DRX paging cycle of the subset of I-DRX paging cycles.

Aspect 8: The method of any of aspects 6 through 7, wherein receiving the first control signaling comprises: receiving the first control signaling indicating the coordination configuration indicating that I-DRX paging cycles of the subset of I-DRX paging cycles are consecutive.

Aspect 9: The method of aspect 8, wherein receiving the first control signaling comprises: receiving the first control signaling indicating the coordination configuration indicating a temporally last I-DRX paging cycles in the subset of I-DRX paging cycles.

Aspect 10: The method of any of aspects 8 through 9, wherein receiving the first control signaling comprises: receiving the first control signaling indicating the coordination configuration indicating a quantity of I-DRX paging cycles in the subset of I-DRX paging cycles.

Aspect 11: The method of aspect 6, wherein receiving the first control signaling comprises: receiving the first control signaling indicating the coordination configuration indicating that I-DRX paging cycles of the subset of I-DRX paging cycles are staggered.

Aspect 12: The method of aspect 11, wherein receiving the first control signaling comprises: receiving the first control signaling indicating the coordination configuration indicating a position of the subset of I-DRX paging cycles within the set of I-DRX paging cycles.

Aspect 13: The method of any of aspects 1 through 12, further comprising: identifying, based at least in part on an identifier associated with the UE, a paging occasion from a plurality of paging occasions of the I-DRX paging cycle, wherein receiving the second control signaling comprises receiving the second control signaling via the paging occasion.

Aspect 14: The method of any of aspects 1 through 13, wherein receiving the first control signaling comprises: receiving an indication of a paging occasion from a plurality of paging occasions, wherein each I-DRX paging cycle comprises the plurality of paging occasions, wherein receiving the second control signaling comprises receiving the second control signaling via the paging occasion.

Aspect 15: A method for wireless communications at a network entity, comprising: transmitting, to a UE in a connected mode with the network entity, first control signaling indicating a coordination configuration, the coordination configuration indicating a subset of I-DRX paging cycles from a set of I-DRX paging cycles, the subset of I-DRX paging cycles associated with an indication of a TRS availability or an indication of an SI change message availability; transmitting, to the UE via an I-DRX paging cycle of the subset of I-DRX paging cycles in accordance with the coordination configuration, second control signaling indicating an availability of a TRS in a TRS resource in the I-DRX paging cycle or an availability of an SI change message in the I-DRX paging cycle; and transmitting, to the UE, the TRS or the SI change message in accordance with second control signaling.

Aspect 16: The method of aspect 15, further comprising: transmitting third control signaling indicating a set of TRS resources comprising the TRS resource, wherein the second control signaling indicates respective availabilities for a set of TRSs in the set of TRS resources.

Aspect 17: The method of aspect 16, further comprising: transmitting, with the third control signaling, an indication of a duration in I-DRX paging cycles associated with the indication of the TRS availability for the set of TRS resources, wherein the respective availabilities of the set of TRSs are applicable for the duration.

Aspect 18: The method of aspect 17, further comprising: transmitting a second TRS in a second I-DRX paging cycle subsequent to the I-DRX paging cycle based at least in part on the second control signaling, wherein the duration is at least two I-DRX paging cycles.

Aspect 19: The method of any of aspects 16 through 18, wherein transmitting the third control signaling comprises: transmitting the third control signaling via an SIB.

Aspect 20: The method of any of aspects 15 through 19, wherein transmitting the first control signaling comprises: transmitting the first control signaling indicating the coordination configuration indicating a quantity of I-DRX paging cycles in the set of I-DRX paging cycles.

Aspect 21: The method of aspect 20, wherein transmitting the first control signaling comprises: transmitting the first control signaling indicating the coordination configuration indicating a temporally first I-DRX paging cycle of the subset of I-DRX paging cycles

Aspect 22: The method of any of aspects 20 through 21, wherein transmitting the first control signaling comprises: transmitting the first control signaling indicating the coordination configuration indicating that I-DRX paging cycles of the subset of I-DRX paging cycles are consecutive.

Aspect 23: The method of aspect 22, wherein transmitting the first control signaling comprises: transmitting the first control signaling indicating the coordination configuration indicating a temporally last I-DRX paging cycles in the subset of I-DRX paging cycles.

Aspect 24: The method of any of aspects 22 through 23, wherein transmitting the first control signaling comprises: transmitting the first control signaling indicating the coordination configuration indicating a quantity of I-DRX paging cycles in the subset of I-DRX paging cycles.

Aspect 25: The method of aspect 20, wherein transmitting the first control signaling comprises: transmitting the first control signaling indicating the coordination configuration indicating that I-DRX paging cycles of the subset of I-DRX paging cycles are staggered.

Aspect 26: The method of aspect 25, wherein transmitting the first control signaling comprises: transmitting the first control signaling indicating the coordination configuration indicating a position of the subset of I-DRX paging cycles within the set of I-DRX paging cycles.

Aspect 27: The method of any of aspects 15 through 26, further comprising: identifying, based at least in part on an identifier associated with the UE, a paging occasion from a plurality of paging occasions of the I-DRX paging cycle, wherein transmitting the second control signaling comprises transmitting the second control signaling via the paging occasion.

Aspect 28: The method of any of aspects 15 through 27, wherein transmitting the first control signaling comprises: transmitting an indication of a paging occasion from a plurality of paging occasions, wherein each I-DRX paging cycle comprises the plurality of paging occasions, wherein transmitting the second control signaling comprises transmitting the second control signaling via the paging occasion.

Aspect 29: An apparatus for wireless communications at a UE, comprising a processor; memory coupled with the processor; and instructions stored in the memory and executable by the processor to cause the apparatus to perform a method of any of aspects 1 through 14.

Aspect 30: An apparatus for wireless communications at a UE, comprising at least one means for performing a method of any of aspects 1 through 14.

Aspect 31: A non-transitory computer-readable medium storing code for wireless communications at a UE, the code comprising instructions executable by a processor to perform a method of any of aspects 1 through 14.

Aspect 32: An apparatus for wireless communications at a network entity, comprising a processor; memory coupled with the processor; and instructions stored in the memory and executable by the processor to cause the apparatus to perform a method of any of aspects 15 through 28.

Aspect 33: An apparatus for wireless communications at a network entity, comprising at least one means for performing a method of any of aspects 15 through 28.

Aspect 34: A non-transitory computer-readable medium storing code for wireless communications at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive, from a network entity while in a connected mode with the network entity, first control signaling indicating a coordination configuration, the coordination configuration indicating a subset of idle mode discontinuous reception paging cycles from a set of idle mode discontinuous reception paging cycles, the subset of idle mode discontinuous reception paging cycles associated with an indication of a tracking reference signal availability or an indication of a system information change message availability;
receive, from the network entity via an idle mode discontinuous reception paging cycle of the subset of idle mode discontinuous reception paging cycles in accordance with the coordination configuration, second control signaling indicating an availability of a tracking reference signal in a tracking reference signal resource in the idle mode discontinuous reception paging cycle or an availability of a system information change message in the idle mode discontinuous reception paging cycle; and
receive, from the network entity, the tracking reference signal or the system information change message based at least in part on the second control signaling.

2. The apparatus of claim 1, wherein the instructions are further executable by the processor to cause the apparatus to:
receive third control signaling indicating a set of tracking reference signal resources comprising the tracking reference signal resource, wherein the second control signaling indicates respective availabilities for a set of tracking reference signals in the set of tracking reference signal resources.

3. The apparatus of claim 2, wherein the instructions are further executable by the processor to cause the apparatus to:
receive, with the third control signaling, an indication of a duration in idle mode discontinuous reception paging cycles associated with the indication of the tracking reference signal availability for the set of tracking reference signal resources, wherein the respective availabilities of the set of tracking reference signals are applicable for the duration.

4. The apparatus of claim 3, wherein the instructions are further executable by the processor to cause the apparatus to:
receive a second tracking reference signal in a second idle mode discontinuous reception paging cycle subsequent to the idle mode discontinuous reception paging cycle based at least in part on the second control signaling, wherein the duration is at least two idle mode discontinuous reception paging cycles.

5. The apparatus of claim 2, wherein the instructions to receive the third control signaling are executable by the processor to cause the apparatus to:
receive the third control signaling via a system information block.

6. The apparatus of claim 1, wherein the instructions to receive the first control signaling are executable by the processor to cause the apparatus to:
receive the first control signaling indicating the coordination configuration indicating a quantity of idle mode discontinuous reception paging cycles in the set of idle mode discontinuous reception paging cycles.

7. The apparatus of claim 6, wherein the instructions to receive the first control signaling are executable by the processor to cause the apparatus to:
receive the first control signaling indicating the coordination configuration indicating a temporally first idle mode discontinuous reception paging cycle of the subset of idle mode discontinuous reception paging cycles.

8. The apparatus of claim 6, wherein the instructions to receive the first control signaling are executable by the processor to cause the apparatus to:
receive the first control signaling indicating the coordination configuration indicating that idle mode discontinuous reception paging cycles of the subset of idle mode discontinuous reception paging cycles are consecutive.

9. The apparatus of claim 8, wherein the instructions to receive the first control signaling are executable by the processor to cause the apparatus to:
receive the first control signaling indicating the coordination configuration indicating a temporally last idle mode discontinuous reception paging cycles in the subset of idle mode discontinuous reception paging cycles.

10. The apparatus of claim 8, wherein the instructions to receive the first control signaling are executable by the processor to cause the apparatus to:
receive the first control signaling indicating the coordination configuration indicating a quantity of idle mode discontinuous reception paging cycles in the subset of idle mode discontinuous reception paging cycles.

11. The apparatus of claim 6, wherein the instructions to receive the first control signaling are executable by the processor to cause the apparatus to:
receive the first control signaling indicating the coordination configuration indicating that discontinuous reception paging cycles of the subset of idle mode discontinuous reception paging cycles are staggered.

12. The apparatus of claim 11, wherein the instructions to receive the first control signaling are executable by the processor to cause the apparatus to:
receive the first control signaling indicating the coordination configuration indicating a position of the subset of idle mode discontinuous reception paging cycles within the set of idle mode discontinuous reception paging cycles.

13. The apparatus of claim 1, wherein the instructions are further executable by the processor to cause the apparatus to:
identify, based at least in part on an identifier associated with the UE, a paging occasion from a plurality of paging occasions of the idle mode discontinuous reception paging cycle, wherein receiving the second control signaling comprises receiving the second control signaling via the paging occasion.

14. The apparatus of claim 1, wherein the instructions to receive the first control signaling are executable by the processor to cause the apparatus to:
receive an indication of a paging occasion from a plurality of paging occasions, wherein each idle mode discontinuous reception paging cycle comprises the plurality of paging occasions, wherein receiving the second control signaling comprises receiving the second control signaling via the paging occasion.

15. An apparatus for wireless communications at a network entity, comprising:
a processor;
memory coupled with the processor; and
instructions stored in the memory and executable by the processor to cause the apparatus to:
transmit, to a user equipment (UE) in a connected mode with the network entity, first control signaling indicating a coordination configuration, the coordination configuration indicating a subset of idle mode discontinuous reception paging cycles from a set of idle mode discontinuous reception paging cycles, the subset of idle mode discontinuous reception paging cycles associated with an indication of a tracking reference signal availability or an indication of a system information change message availability;
transmit, to the UE via an idle mode discontinuous reception paging cycle of the subset of idle mode discontinuous reception paging cycles in accordance with the coordination configuration, second control signaling indicating an availability of a tracking reference signal in a tracking reference signal resource in the idle mode discontinuous reception paging cycle or an availability of a system information change message in the idle mode discontinuous reception paging cycle; and
transmit, to the UE, the tracking reference signal or the system information change message in accordance with second control signaling.

16. The apparatus of claim 15, wherein the instructions are further executable by the processor to cause the apparatus to:
transmit third control signaling indicating a set of tracking reference signal resources comprising the tracking reference signal resource, wherein the second control signaling indicates respective availabilities for a set of tracking reference signals in the set of tracking reference signal resources.

17. The apparatus of claim 16, wherein the instructions are further executable by the processor to cause the apparatus to:
transmit, with the third control signaling, an indication of a duration in idle mode discontinuous reception paging cycles associated with the indication of the tracking reference signal availability for the set of tracking reference signal resources, wherein the respective availabilities of the set of tracking reference signals are applicable for the duration.

18. The apparatus of claim 17, wherein the instructions are further executable by the processor to cause the apparatus to:
transmit a second tracking reference signal in a second idle mode discontinuous reception paging cycle subsequent to the idle mode discontinuous reception paging cycle based at least in part on the second control signaling, wherein the duration is at least two idle mode discontinuous reception paging cycles.

19. The apparatus of claim 16, wherein the instructions to transmit the third control signaling are executable by the processor to cause the apparatus to:
transmit the third control signaling via a system information block.

20. The apparatus of claim 15, wherein the instructions to transmit the first control signaling are executable by the processor to cause the apparatus to:
transmit the first control signaling indicating the coordination configuration indicating a quantity of idle mode discontinuous reception paging cycles in the set of idle mode discontinuous reception paging cycles.

21. The apparatus of claim 20, wherein the instructions to transmit the first control signaling are executable by the processor to cause the apparatus to:
transmit the first control signaling indicating the coordination configuration indicating a temporally first idle mode discontinuous reception paging cycle of the subset of idle mode discontinuous reception paging cycles.

22. The apparatus of claim 20, wherein the instructions to transmit the first control signaling are executable by the processor to cause the apparatus to:
transmit the first control signaling indicating the coordination configuration indicating that idle mode discontinuous reception paging cycles of the subset of idle mode discontinuous reception paging cycles are consecutive.

23. The apparatus of claim 22, wherein the instructions to transmit the first control signaling are executable by the processor to cause the apparatus to:
transmit the first control signaling indicating the coordination configuration indicating a temporally last idle mode discontinuous reception paging cycles in the subset of idle mode discontinuous reception paging cycles.

24. The apparatus of claim 22, wherein the instructions to transmit the first control signaling are executable by the processor to cause the apparatus to:
transmit the first control signaling indicating the coordination configuration indicating a quantity of idle mode discontinuous reception paging cycles in the subset of idle mode discontinuous reception paging cycles.

25. The apparatus of claim 20, wherein the instructions to transmit the first control signaling are executable by the processor to cause the apparatus to:
transmit the first control signaling indicating the coordination configuration indicating that discontinuous reception paging cycles of the subset of idle mode discontinuous reception paging cycles are staggered.

26. The apparatus of claim 25, wherein the instructions to transmit the first control signaling are executable by the processor to cause the apparatus to:
transmit the first control signaling indicating the coordination configuration indicating a position of the subset of idle mode discontinuous reception paging cycles within the set of idle mode discontinuous reception paging cycles.

27. The apparatus of claim 15, wherein the instructions are further executable by the processor to cause the apparatus to:
identify, based at least in part on an identifier associated with the UE, a paging occasion from a plurality of paging occasions of the idle mode discontinuous reception paging cycle, wherein transmitting the second control signaling comprises transmitting the second control signaling via the paging occasion.

28. The apparatus of claim 15, wherein the instructions to transmit the first control signaling are executable by the processor to cause the apparatus to:
transmit an indication of a paging occasion from a plurality of paging occasions, wherein each idle mode discontinuous reception paging cycle comprises the plurality of paging occasions, wherein transmitting the second control signaling comprises transmitting the second control signaling via the paging occasion.

29. A method for wireless communications at a user equipment (UE), comprising:
receiving, from a network entity while in a connected mode with the network entity, first control signaling indicating a coordination configuration, the coordination configuration indicating a subset of idle mode discontinuous reception paging cycles from a set of idle mode discontinuous reception paging cycles, the subset of idle mode discontinuous reception paging cycles associated with an indication of a tracking reference signal availability or an indication of a system information change message availability;
receiving, from the network entity via an idle mode discontinuous reception paging cycle of the subset of idle mode discontinuous reception paging cycles in accordance with the coordination configuration, second control signaling indicating an availability of a tracking reference signal in a tracking reference signal resource in the idle mode discontinuous reception paging cycle or an availability of a system information change message in the idle mode discontinuous reception paging cycle; and
receiving, from the network entity, the tracking reference signal or the system information change message based at least in part on the second control signaling.

30. A method for wireless communications at a network entity, comprising:
transmitting, to a user equipment (UE) in a connected mode with the network entity, first control signaling indicating a coordination configuration, the coordination configuration indicating a subset of idle mode discontinuous reception paging cycles from a set of idle mode discontinuous reception paging cycles, the subset of idle mode discontinuous reception paging cycles associated with an indication of a tracking reference signal availability or an indication of a system information change message availability;
transmitting, to the UE via an idle mode discontinuous reception paging cycle of the subset of idle mode discontinuous reception paging cycles in accordance with the coordination configuration, second control signaling indicating an availability of a tracking reference signal in a tracking reference signal resource in the idle mode discontinuous reception paging cycle or an availability of a system information change message in the idle mode discontinuous reception paging cycle; and
transmitting, to the UE, the tracking reference signal or the system information change message in accordance with second control signaling.
